(19) United States
(12) Patent Application Publication
(10) Pub. No.: US 2013/0192384 A1
(43) Pub. Date: Aug. 1, 2013

(54) METHOD FOR TESTING TENSILE STRENGTH OF AN ELECTRICALLY NONCONDUCTIVE MATERIAL

(71) Applicants: HAO CHANG, Lansdale, PA (US); George J. Broda, III, Wilmington, DE (US); Clifford K. Deakyne, Wilmington, DE (US); Stacy M. Hamlet, Newark, DE (US)

(72) Inventors: HAO CHANG, Lansdale, PA (US); George J. Broda, III, Wilmington, DE (US); Clifford K. Deakyne, Wilmington, DE (US); Stacy M. Hamlet, Newark, DE (US)

(73) Assignee: E I DU PONT DE NEMOURS AND COMPANY, Wilmington, DE (US)

(21) Appl. No.: 13/559,796

(22) Filed: Jul. 27, 2012

Related U.S. Application Data
(60) Provisional application No. 61/523,493, filed on Aug. 15, 2011.

(51) Int. Cl. G01N 3/18

(52) U.S. Cl. CPC G01N 3/18
USPC 73/834; 73/826

(57) ABSTRACT

The invention pertains to a method and apparatus for testing the tensile strength of a material, particularly an electrically nonconductive material, at a temperature above ambient temperature. The test method is useful for determining the potential suitability of a material for use as a development medium in a thermal development process for preparing relief printing forms. One embodiment of the method includes mounting the strip between upper and lower chucks of a tensile test machine; positioning a means for generating a hot air stream adjacent the strip so that the stream does not impinge the strip; heating the hot air stream to a predetermined temperature above ambient temperature; repositioning the hot air stream so that the stream impinges the strip; and starting the tensile testing when the hot air stream at the predetermined temperature begins heating the strip.

### BACKGROUND OF THE INVENTION

1. Field of the Disclosure

This invention pertains to a method for testing tensile strength of a material, particularly an electrically nonconductive material.

2. Description of Related Art

Flexographic printing plates are well known for use in printing surfaces which range from soft and easy to deform to relatively hard, such as packaging materials, e.g., cardboard, plastic films, aluminum foils, etc.. Flexographic printing plates can be prepared from photosensitive elements containing photopolymerizable compositions, such as those described in U.S. Pat. Nos. 4,323,637 and 4,427,759. The photopolymerizable compositions generally comprise an elastomeric binder, at least one monomer and a photoinitiator. Photosensitive elements generally have a photopolymerizable layer interposed between a support and a coversheet or multilayer cover element. Upon imagewise exposure to actinic radiation, photopolymerization of the photopolymerizable layer occurs in the exposed areas, thereby curing and rendering insoluble the exposed areas of the layer. Conventionally, the element is treated with a suitable solution, e.g., solvent or aqueous-based washout, to remove the unexposed areas of the photopolymerizable layer leaving a printing relief which can be used for flexographic printing. However, developing systems that treat the element with a solution are time consuming since drying for an extended period (0.5 to 24 hours) is necessary to remove absorbed developer solution.

As an alternative to solution development, a “dry” thermal development process may be used which removes the unexposed areas without the subsequent time-consuming drying step. In a thermal development process, the photosensitive layer, which has been imagewise exposed to actinic radiation, is contacted with an absorbent material at a temperature sufficient to cause the composition in the unexposed portions of the photosensitive layer to soften or melt and flow into an absorbent material. See U.S. Pat. No. 3,060,023 (Burg et al.); U.S. Pat. No. 3,264,103 (Cohen et al.); U.S. Pat. No. 5,015,556 (Martens); U.S. Pat. No. 5,175,072 (Martens); U.S. Pat. No. 5,215,859 (Martens); and U.S. Pat. No. 5,279,697 (Peterson et al.). The exposed portions of the photosensitive layer remain hard, that is do not soften or melt, at the softening temperature for the unexposed portions. The absorbent material collects the softened un-irradiated material and then is removed from the photosensitive layer. The cycle of heating and contacting the photosensitive layer may need to be repeated several times in order to sufficiently remove the softened composition from the un-irradiated areas and form a relief structure suitable for printing. After such processing, there remains a raised relief structure of irradiated, hardened composition that represents the irradiated image.

Processors for thermal development of flexographic printing elements are known. U.S. Pat. No. 5,279,697 and U.S. Pat. No. 6,797,454 each describe an automated process and apparatus for handling an irradiated printing element and accomplishing repeated heating and pressing to remove the unirradiated composition from the element with a web of absorbent material. The apparatus includes a hot roll that delivers the absorbent material to the photosensitive element. The absorbent material contacts the hot surface of the hot roll elevating the temperature of the absorbent material. The heated absorbent material transfers the heat to the photosensitive element, melting a portion of the composition layer, and absorbs at least a portion of the softened or liquefied composition layer. The cycle of heating and contacting the photosensitive layer may need to be repeated several times in order to sufficiently remove the softened composition from the un-irradiated areas and form a relief structure suitable for printing. After such processing, there remains a raised relief structure of irradiated, hardened composition that represents the irradiated image.

A problem sometimes arises during thermal development where the absorbent material is a continuous web, and in particular a web of nonwoven material. After the absorbent material contacts the photosensitive element and collects the softened unirradiated material, the web of absorbent material, which is under tension, can adhere to the photosensitive element, and/or can stretch and/or distort while being separated from the photosensitive element. The adhesion or the ability to separate the absorbent web from the element can vary with the relief image that is forming. Portions of the relief image that are polymerized and therefore less tacky, peel easily as the web separates. Whereas the absorbent web may adhere and peel after the nip in portions of the relief image that are unpolymerized and thus are tacky or molten polymer.

In some cases, the web of absorbent material has insufficient strength to separate from the photosensitive element and remains adhered to the photosensitive element as it is rotated by the support drum which causes the web to wrap about the drum. As such operations are suspended for a considerable downtime while the web is cut, removed, and re-threaded through the processor. In some other cases, the web has insufficient strength to withstand the force necessary to peel the nonwoven from the element, and the web may break, or tear, or delaminate from itself, and even leave patches of absorbent material remaining on the photosensitive element. When the web breaks, the web would not be present to remove the tacky molten polymer from the heated photosensitive element, and the polymer can flow onto various surfaces in the processor including the hot roll and the drum support roll. As such operations are suspended for a considerable downtime while the web is re-threaded through the processor and the tacky molten polymer is removed from various interior surfaces. If the molten polymer remains on the hot roll, the polymer tends to build up and harden on the roll, which can then impress patterns into the surface of subsequently processed printing forms. Also, since the photosensitive element may not be useable in these cases, additional time and materials are consumed by the preparation of a new photosensitive element.

In some other cases, the web adheres to the photosensitive element to an extent that the web can stretch and/or distort while being separated or peeled from the element. Forces associated with the peeling of the web from the element change when the web stretches and/or distorts, which can induce defects into the element such as waves, variations in relief formation, etc. Printing with printing forms having variations in relief can be a problem particularly for high quality printing as areas with shallow relief can accumulate dirt that ultimately prints on the substrate, and relief areas that are too deep can weaken fine printing elements such as highlight dots and fine lines.

The stretching and/or distorting web can adhere to the photosensitive element to such an extent that the web can even cause the photosensitive element to lift from its support surface while being separated or peeled from the element. The removal of the absorbent web from the still warm photosensitive element can induce defects in the resulting relief element. Stretching and/or distorting of the web particularly while peeling, and the lifting of the photosensitive element while the element is still hot, can bend the element and induce strains in the structure of the element which create a defect, called waves, in the resulting relief element. The non-uniform strains imparted in the element while the support is at a temperature higher than the glass transition temperature result in deformations that remain after the element has cooled or returned to room temperature. The deformations are waves of localized distortions resulting in a non-planar topography of the photosensitive element. Because of the uncontrolled nature of the web in thermal development of the prior art, waves of distortions can form in different locations in each element processed.

Relief printing forms having waves result in poor print performance. In multicolor printing, when one or more of the relief printing forms have waves the printed image has poor registration. Even in single color printing, waves in the relief printing form may print an image that is not an accurate reproduction of its original, so called image infidelity, by printing straight lines as curves for example. Further, the relief printing form having waves may incompletely print the image due to intermittent contact of the inked surface of the printing form to the printed substrate.

The performance of a web of an absorbent material during thermal development is essential to successful preparation of a relief printing form from a photopolymerizable precursor. The web of the absorbent material, which may also be referred to as a development medium, should not wrap, stretch, distort, tear, break, delaminate, lint, or deteriorate or can only occur to the extent that defects are not induced into the resulting relief printing form. The use of the development medium, such as a nonwoven, in thermal development process places unique performance requirements upon the medium as it needs to withstand the rigors of thermal development. The thermal development process requires that the development medium have strength suitable to contact and separate from tacky or molten polymeric material at a temperature above ambient, typically a significantly elevated temperature. Elevated temperatures associated with thermal development are generally between 40-230° C., and typically between 80 and 180° C., but are for a relatively short period of time (0.25 to 10 seconds), that is while in contact with the hot roll and/or heated photosensitive element. In most instances, it is also necessary that the development medium also wicks, blots, or removes molten polymeric material in depth from the element in order to form the relief structure of the printing form. In addition, the development medium is tensioned in the thermal development apparatus to assure suitable travel along its path and sufficient contact with the photosensitive element. It is desirable for the development medium to have sufficient strength under tension during thermal development such that the medium does not break, tear, delaminate, wrap, stretch, distort, lint, or otherwise deteriorate which disrupts the development process and/or induces defects in the element.

It can be difficult to determine potential suitability of particular materials for use as the development medium in thermal development process for preparing relief printing forms, as conventional test methods for determining strength are not representative of the in-service use of the development medium. In particular, ASTM D5035 is a standard test method to measure polymeric sheet strength (such as the materials used as development medium) at an elevated temperature, which uses a heating chamber that surrounds the test sample and grips that hold the sample. The standard procedure includes loading the sample into the chamber at room temperature, and heating the chamber to the desired test temperature, before tensile testing of the sample begins. However, the heating of the chamber to the elevated temperature also heats the sample for the same time period such that the properties of the sample material can be influenced. It is theorized that the certain materials, such as nonwovens, may anneal during the time that it takes to heat the chamber, and as such change the tensile strength of the sample as measured. The measured tensile strength of the sample heated for an extended period of time may not be indicative of the actual tensile strength of the medium exhibited during thermal development since the development material is rapidly heated by a heated roll for a significantly short time period.

It is thus desirable to provide a method for determining the tensile strength of a material for use as development medium in a thermal development process for preparing relief printing forms from photopolymerizable precursors.

### SUMMARY

In accordance with this invention there is provided a method for testing tensile strength of an electrically nonconductive strip of a material at an above-ambient temperature. The method includes mounting the strip between upper and lower chucks of a tensile test machine per ASTM-D5035 tensile testing standard; positioning a means for generating a hot air stream adjacent the strip so that the stream does not impinge the strip; heating the hot air stream to a predetermined temperature above ambient temperature; repositioning the hot air stream so that the stream impinges the strip; and starting the tensile testing when the hot air stream at the predetermined temperature begins heating the strip.

In accordance with another aspect of this invention there is provided an apparatus for testing tensile strength of an electrically nonconductive strip at an above-ambient temperature. The apparatus includes upper and lower chucks of a tensile test machine adapted to mount the strip per ASTM-D5035 tensile testing standard; means positioned adjacent the strip for generating a hot air stream at a predetermined temperature above ambient temperature; and means for repositioning the generating means so that the hot air stream moves from a position that does not impinges the strip to a position that impinges the strip.

In accordance with another aspect of this invention there is provided a method for testing tensile strength of an electrically nonconductive strip of a material at an above-ambient temperature. The method includes mounting the strip between upper and lower chucks of a tensile test machine per ASTM-D5035 tensile testing standard; positioning a heatable member adjacent the strip so that the member does not contact the strip; heating the member to a predetermined temperature above ambient temperature; repositioning the member so that the member contacts the strip; and starting the tensile testing when the member heated at the predetermined temperature begins heating the strip.

### BRIEF DESCRIPTION OF THE DRAWINGS

The invention can be more fully understood from the following detailed description thereof in connection with the accompanying drawing described as follows:

FIG. 1 is a perspective view of a schematic representation of one embodiment of an apparatus for testing tensile strength of an electrically non-conductive strip according to the present invention that includes a tensile test machine having a grip of an upper chuck and a grip of a lower chuck that are adapted to mount the strip there between; means for generating a hot air stream that is positioned adjacent the strip; and a means for repositioning the generating means so that the hot air stream moves from a position that does not impinge the strip to a position that impinges the strip. In FIG. 1 the means for generating a hot air stream is a hot air gun which is positioned adjacent the strip having the air stream directed so as not to impinge the strip.

FIG. 2 is a perspective view of a schematic representation of one embodiment of the apparatus for testing tensile strength as described in FIG. 1, except that in FIG. 2 the hot air gun as the means for generating a hot air stream is positioned with the air stream impinging the strip.

### DESCRIPTION OF THE PREFERRED EMBODIMENTS

Throughout the following detailed description, similar reference characters refer to similar elements in all figures of the drawings.

The present invention concerns a method for testing tensile strength of a material, in particular an electrically nonconductive material, at an above-ambient temperature. The method is useful for testing electrically nonconductive materials that experience a temperature above ambient temperature for a relatively short period of time. The relatively short period of time is a period of time that is less than a time it would take an oven chamber, which encloses the test machine or the grips of the upper and lower chucks and the test strip, to reach the predetermined temperature. The test is conducted in real-time simulating the conditions that the material experiences in its end-use. The present test method is useful for testing the tensile strength of a sheet material at a temperature between its glass transition temperature, Tg, and its melting point or degradation temperature of the film material, particularly when the sheet material momentarily experiences the above ambient temperature. The tensile test method is specifically useful for determining the tensile strength of a material that is used as a development medium in a thermal process for preparing relief printing forms from photopolymerizable precursors. Standard test methods for characterizing mechanical properties of a material used as a development medium could not adequately predict performance of the material in use during thermal development. The present method is representative of in-service use of the materials and thus facilitates determining potential suitability of various materials for use in a thermal development process. The electrically nonconductive strip or electrically nonconductive material encompasses sheet materials including polymeric films and polymeric nonwovens. The strip of material used in the present method for tensile testing encompasses any of various materials suitable for use as a development medium in a thermal development process as described below. Electrically non-conductive material or electrically non-conductive strip will simply be referred to hereinafter as a strip or a material.

In the context of this disclosure, a number of terms shall be utilized.

As used herein, the term “ambient temperature” or, equivalently “room temperature,” has its ordinary meaning as known to those skilled in the art and may include temperatures within the range of about 16° C. (60° F.) to about 32° C. (90° F.). The term “above-ambient temperature” includes temperatures greater than about 33° C.

As used herein, the term “electrically nonconductive” material or strip means a material or strip that does not conduct electrons or current, or substantially does not conduct electrons or current, or substantially less electrons or current than conventional conductive materials, such as copper.

As used herein, the term “printing form” means an object (e.g., in the form of a cylinder, block, or plate) used to apply ink onto a surface for printing.

As used herein, the term “photosensitive element” or “precursor” means an element that can be converted into a printing form, particularly a relief printing form. The precursor includes at least a layer of photopolymerizable composition composed at least of a binder, at least one ethylenically unsaturated compound, and a photoinitiator.

As used herein, the term “relief” printing form means a printing form that prints from an image area, where the image area of the printing form is raised and the non-image area is depressed.

As used herein, the term “tensile strength” or, equivalently, “peak strength” means a maximum force or load that a material or strip exhibits when tested according to the present method.

The tensile test machine may also be referred to as a tensilometer. Tensilometers suitable for use in the present test method are manufactured by Instron (Canton, Mass., USA), and also by MTS (Eden Prairie, Minn., USA). The tensilometer, or tensile tester, may be modified to accommodate particular steps of the method to include a means for generating a hot air stream and a means for positioning (and repositioning) the hot air stream to impinge upon a strip of a test material. One suitable tensile tester for use in the present method is an Instron Model #1125, with an MTS renew package, having an Instron tensile “C” load cell of 50 lb (22.7 kilogram-force). Generally, the tensilometer includes several sets of grips, any of which may be used in the present method. In most embodiments, pneumatically-operated standard grips for high temperature testing (though the grips will not be heated).

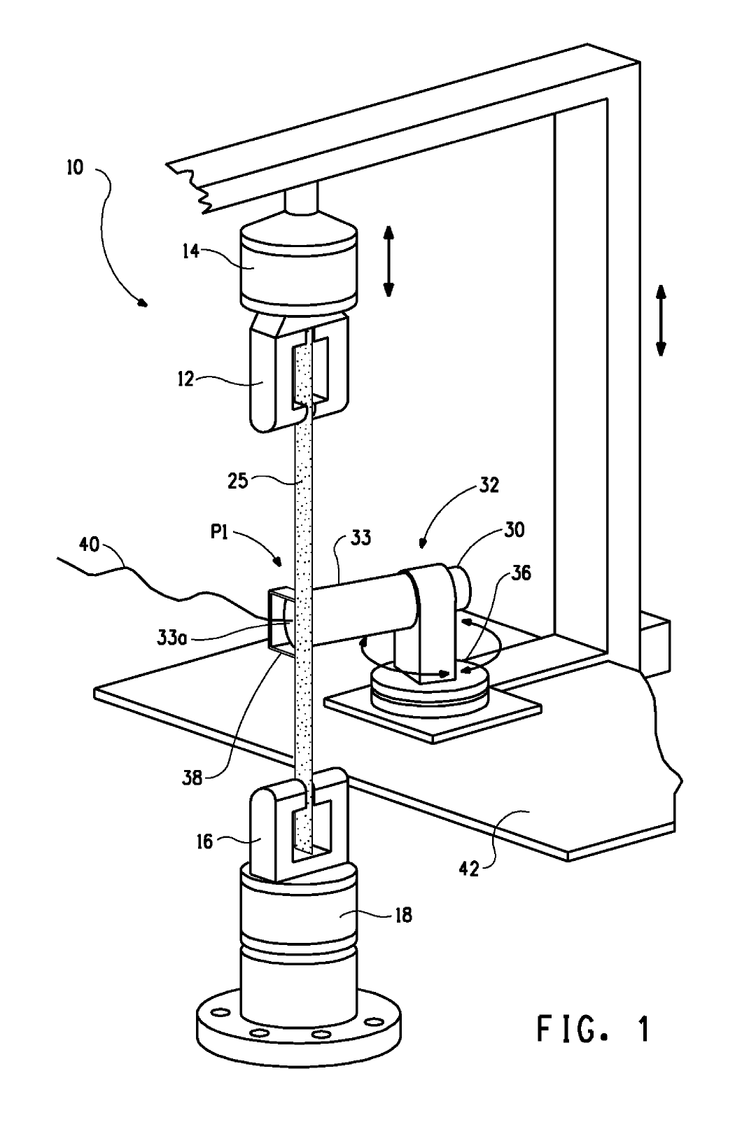

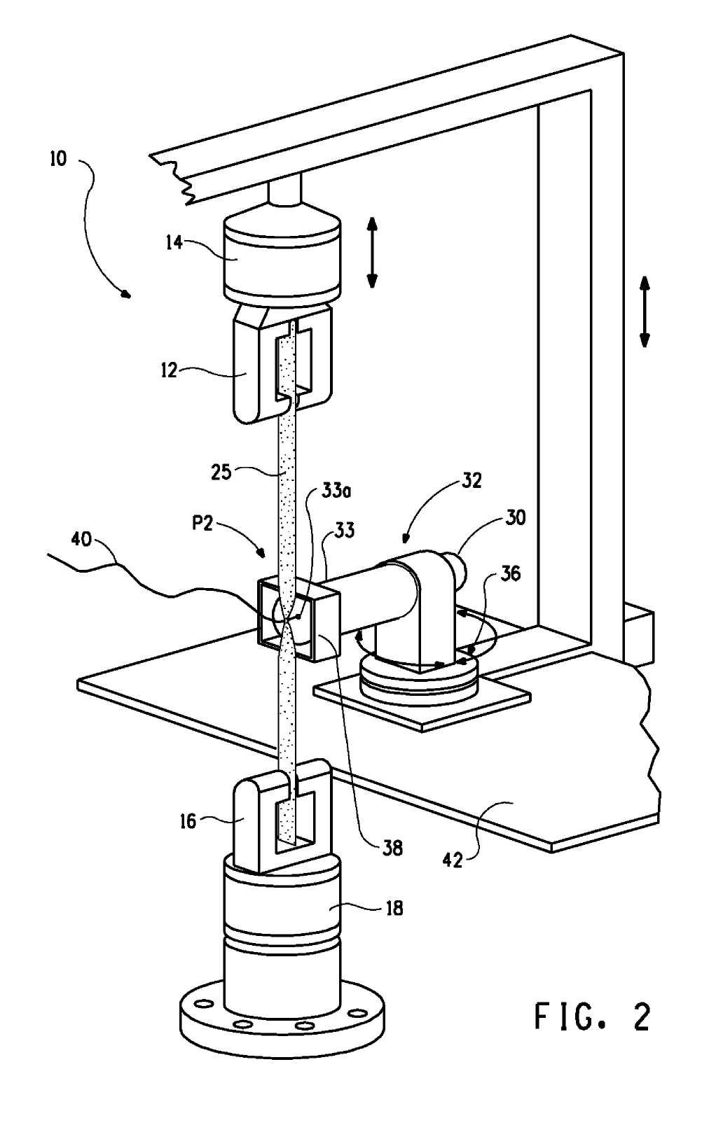

One embodiment of an apparatus 10 for testing tensile strength of an electrically non-conductive strip according to the present invention is a tensile test machine 10 with modifications as shown FIG. 1 and FIG. 2. The apparatus 10 includes a grip 12 of an upper chuck 14 and a grip 16 of a lower chuck 18 that are adapted to mount the strip 25 there between; means for generating 30 a hot air stream that is positioned adjacent the strip in FIG. 1; and a means for positioning 36 the generating means so that the hot air stream moves from a position P1 that does not impinge the strip to a position P2 that impinges the strip.

In most embodiments, each of the grips 12, 16 is jaw-like having opposable members each with a contact surface that is parallel and centered with respect to the other in the same clamp. The opposable members of the grips can open and close to mount and hold the strip between the contact surfaces. In most embodiments, at least the contact surface of the grips 12, 16 is covered with about 1 mm thick elastomeric material having a durometer of about 50 to 90 Shore A hardness. In some embodiments, the grips 12, 16 are pneumatically controlled to assure constant or substantially constant pressure to grip or hold the ends during the tensile test. In another embodiment, the grips can be controlled by a spring, with a lever used to open the grip faces to load the sample. In yet another embodiment, the grips can be a mechanical type where the grip faces are opened and closed by rotating a screw that is attached to one side.

The standard test method ASTM D5035 entitled Breaking Force and Elongation of Textile Fabrics (Strip Method) for determining strength of sheet materials is hereby incorporated by reference in its entirety. The ASTM D5035-11 standard is the current standard for determining the tensile strength, i.e., the breaking force, of a material, particularly for textile fabrics that includes wovens, nonwovens, and felted fabrics; and provides the desired basic standard testing guidelines to be followed with modifications as noted for the present invention. In most embodiments, the present method follows the standard ASTM 5035 relative to the following system identifiers: the type of specimen is “1C”—25 mm (1.0 inch) cut strip test (section 4.2.1.3); and the type of tensile testing machine is “E”—constant-rate-of-extension (CRE) (section 4.2.2.1). In other embodiments, the present method follows the standard ASTM 5035 relative to the following system identifiers: the type of specimen is “1 C”—25mm (1.0 inch) cut strip test (section 4.2.1.3); and the type of tensile testing machine is “T”—constant-rate-of-traverse (CRT) (section 4.2.2.3). In yet other embodiments, the present method follows the standard ASTM 5035 relative to the following system identifiers: the type of specimen is “1 R”—25mm (1.0 inch) ravel strip test (section 4.2.1.1); and the type of tensile testing machine is “E”—constant-rate-of-extension (CRE) (section 4.2.2.1). The use of specific test system parameters is dependent at least upon the particular sheet material that is to be tested. In most embodiments of the present method the tensile strength is determined with a strip that is dry.

Though the ASTM D5035-11 standard is the current standard an older or prior standard ASTM D1682 for tensile testing could also be used. Though ASTM D5035-11 is for testing of textile fabrics, use of ASTM D5035-11 with the present method is applicable for strength testing of any sheet materials including woven substrates, nonwoven substrates, woven polymeric substrates, nonwoven polymeric substrates, knitted fabrics, felted fabrics, and polymeric films (e.g., polyethylene terephthalate). Though ASTM D882 is used for tensile strength testing of polymeric films, the use of ASTM D5035 for the present method is better suited for polymeric films that experience localized heating because in ASTM D882 the specimen size becomes smaller with increasing strain to failure.

ASTM D4594 covers testing of geotextiles at temperature that is not at room temperature, and reference the test procedure of ASTM D5035. In general, testing at temperature that is not room temperature, e.g., at an elevated temperature, is normally done according to an ASTM procedure but a chamber is used to create suitable temperature environment for the material.

The present method includes mounting a material between an upper chuck 14 and a lower chuck 18 of a tensile test machine per ASTM-D5035 tensile testing standard. The material is cut into a strip 25, typically about 1 inch (2.54 cm) wide by about 14 inch (35.6 cm) long, and can be conditioned, such as being held at room temperature of 23° C. and 50% relative humidity for a period of time, prior to mounting. The strip 25 is mounted by securing one end of the strip in a grip 12 of the upper chuck 14 and the opposite end of the strip in the grip 16 of the lower chuck 18. In most embodiments, the width of contact surfaces of the grips 12, 16 is wider than the cut width of strip 25 to minimize slippage of the strip during testing. In most embodiments, the strip 25 is oriented vertically between the grips 12, 16 of the upper and lower chucks 14, 18. Some portion of each end of the strip 25 is held by the grips, typically about 1 inch (2.54 cm), but can be more or less. Some small portion of each end of the strip 25 may extend beyond the grips of the upper and lower chucks. A sufficient length of the strip 25 is positioned between the grips of the upper and lower chucks to avoid any effect caused by the grips holding the strip during the test, so called edge effect. In most embodiments, the length of the strip 25 between the grips of the upper and lower chucks is about 6 inch (15.2 cm). This length will provide about 2 inch (5.1 cm) of the strip 25 from each grip for mitigating edge effects, and a central section of the length between the grips of the upper and lower chucks that is about 2 inch (5.1 cm) that is a gauge length, or a portion of the strip which will be tested. In other embodiments, the length of the strip 25 between the grips of the upper and lower chucks is about 7 inch (17.8 cm), which will provide about 2 inch (5.1 cm) of the strip from each grip to mitigate edge effect, and a central section, i.e., gauge length, for testing of about 3 inch (7.6 cm).

In one embodiment, the method includes positioning a means for generating 30 a hot air stream adjacent the strip 25 so that the stream does not impinge the strip. In this embodiment, the means for generating a hot air stream uses convection heating, and in particular, forced air convection heating to test the strip 25 at the predetermined temperature. In most embodiments, the means for generating a hot air stream includes a stream of only heated air, and the stream of hot air does not include a flame or stream of fire. The present method is not intended to determine flammability of a nonconductive material, or strength of a nonconductive material while exposed to flames or fire. In most embodiments, the means for generating 30 a hot air stream is a hot air gun 32 that is capable of heating the temperature of the air stream emitting from an opening 33a of a nozzle 33 of the air gun. In one embodiment, the air gun 32 is capable of producing a constant airflow of about 20 to about 50 standard cubic feet per minute (scfm) (about 566 to about 1416 liters per minute) that emits from the nozzle opening 33a of the air gun. In another embodiment, the air gun 32 is capable of producing a constant or substantially constant airflow of about 45 to about 49 scfm (about 1274 to about 1388 liters per minute), and preferably airflow of 47 scfm (about 1330 liters per minute). In another embodiment, the air gun is capable of producing a constant airflow of about 25 to about 30 scfm (about 708 to about 850 liters per minute), and preferably airflow of 27.5 scfm (779 liters per minute). The airflow and temperature of the air generated by the hot air gun 32 are selected in order to maintain a desired temperature at the strip 25, that is the predetermined temperature at the strip, during the tensile test. The nozzle opening 33a of the air gun 32 has a diameter that in some embodiments is 2 inch (5.1 cm), and in other embodiments is 3 inch (7.6 cm). The length of the strip between the grips 12, 16 of the upper and lower chucks 14, 18 may be influenced by the diameter of the nozzle opening 33a of the air gun.

One suitable means for generating 30 a hot air stream is a Scorpion Air Heat Gun, Model F075615 hot gun (made by Sylvania, located in Danvers, Mass., USA). In embodiments in which the nozzle opening 33a of the gun 32 is at a distance of about 2.5 inch (6.4 cm) from the strip 25, the Scorpion gun is set to have the air temperature as it exits the nozzle at 232° C. and airflow of 27.5 scfm, to provide a predetermined temperature of 170° C. at the surface of the strip. Other settings of the air temperature exiting the nozzle and the airflow would be used if the distance from the nozzle to the strip were different, and/or if a different predetermined temperature at the strip during the tensile test is desired.

Optionally, the hot air gun 32 can include a collar 38 that extends beyond the nozzle opening 33a. The collar 38 attaches or is mounted at the nozzle opening 33a of the hot air gun 32 so that hot air emits from an end of the collar opposite the nozzle opening. There are several advantages to including the collar 38 at the nozzle opening of the hot air gun 32. The collar 38 can help to maintain constant the distance from the nozzle opening 33a to the surface of the strip 25, i.e., the separation distance. A thermocouple 40 can be easily positioned at an end of the collar 38 opposite an end connecting to the nozzle opening 33a, to monitor the temperature of the air at the strip 25 and determine if the predetermined temperature of the air has been reached. The collar 38 can also minimize or block the surrounding (cooler) air being pulled into the hot air stream so that it is easier to maintain the temperature of the air at the strip. In some embodiments, the shape of the opposite end of the collar 38 that is adjacent the surface of the strip 25 is rectangular to correspond to a shape of the central portion of the strip, which is the gauge length of the strip. Since the nozzle opening of most commercially available air guns is circular or cylindrical, a more uniform airflow impinging the strip can be provided by having the shape the opposite end of the collar 38 matched to the (shape of) gauge length of the strip.

The air gun 32 as the means for generating 30 the hot air stream can be mounted onto a frame of the tensile test machine or a separate carriage assembly so that the nozzle 33 of the air gun can be positioned to direct the air stream away from the test strip at a position P1 (i.e., air stream does not impinge the strip), and to direct the air stream to impinge the test strip at a position P2. In most embodiments, the means for generating the hot air stream 30 is mounted so that the nozzle 33 moves with the test area of the strip, that is, the gauge length, as the strip elongates during the test. In one embodiment as shown in FIG. 1 and FIG. 2, the means for generating 30 the hot air stream is mounted onto a platform 42 that is attached to the frame of one of the upper chuck 14 or the lower chuck 18 that moves when load is applied to the strip 25 during the test. In another embodiment, the means for generating 30 the hot air stream is mounted onto a separate frame or carriage having a motor that is synchronized to move at the same time and rate as the moving chuck of the test machine, so that the nozzle 33 will continue to direct the air stream at the gauge length of the strip 25 as the strip elongates.

The present method includes heating the hot air stream to a predetermined temperature above ambient temperature. The means for generating 30 a hot air stream, that is, the hot air gun 32 can include in one embodiment a thermostat for adjusting the temperature of the air to a predetermined temperature that is above ambient temperature. In another embodiment, a variac can be used with an air gun to vary the voltage of the air gun and thus the temperature of the air. Heating of the air stream occurs while the air gun 30 is adjacent the strip 25 and the nozzle 33 is directed so that the stream does not impinge the strip in position P1. A thermocouple 40, which is placed adjacent to the sample in the heating zone of the nozzle 33 (or opposite end of collar 38) and connected to a display, is located in the stream of air to measure the temperature of the air stream emitting from the air gun 32. In most embodiments, the thermocouple 40 is positioned at a distance from the nozzle opening 33a that is the same or substantially the same as a distance of the test strip 25 from the nozzle when the tensile test is started. The temperature above ambient temperature, i.e., the predetermined temperature, is selected to correspond to a temperature the material experiences in its end use. The predetermined temperature can be any temperature above ambient temperature, and between the glass transition temperature, Tg, of the strip material and the melting point or degradation temperature of the strip material. In most embodiments the predetermined temperature is a temperature from about 90 to about 230° C. In some embodiments, the predetermined temperature is a temperature from about 130 to about 200° C. In some embodiments, the predetermined temperature is a temperature from about 150 to about 190° C. In some other embodiments, the predetermined temperature is a temperature from about 160 to about 175° C. In yet other embodiments, the predetermined temperature is or substantially is 170° C. In yet other embodiments, the predetermined temperature is or substantially is 175° C. In yet other embodiments, the predetermined temperature is or substantially is 165° C. In yet other embodiments, the predetermined temperature is or substantially is 163° C. The selection of the predetermined temperature suitable for testing of the nonconductive material strip can be based on at least the particular material as the development medium and the temperature or range of temperature at which thermal development occurs. The thermostat on the air gun is changed to adjust the temperature of the air stream until the display of the thermocouple indicates that the air stream at the set airflow and distance from the strip has reached the predetermined temperature.

The present method includes means for positioning 36 the hot air stream so that the stream impinges the strip. The means for generating 30 hot air stream is mounted on to the platform 42 or frame of the apparatus 10 so that it moves from the first position P1 in which the hot air stream from the nozzle does not impinge the strip to a second position P2 in which the air stream from the nozzle does impinge the strip. In some embodiments the air gun 32 is mounted with the capability to pivot between the first position P1 and the second position P2 that functions as the means for positioning 36 to position and reposition the means for generating 30 heat. In this embodiment, a base plate of the hot air gun 32 is mounted to the movable platform 42 by a single loose screw such that the air gun aligns with the test strip in the second position P2. The air gun 32 is manually rotated by pivoting about the screw to direct the nozzle of air gun away from the strip to the first position P1 until the test is underway when the air gun is pivoted to the second position P2. A second screw or a pin can also be used at the edge of the base plate to act as a stop to insure that the air gun returns to the same position/s. In another embodiment, the hot air gun 32 is mounted or secured to a rotatable coupling, such as a “Lazy Susan” bearing, which is mounted to the platform 42. FIG. 1 and FIG. 2 show the air gun 32 secured to the rotatable coupling of a Lazy Susan bearing which is mounted to the moveable platform 42.

In some embodiments, the hot air stream is repositioned horizontally by manually pivoting the air gun from the first position to the second position, and is returned to the first position upon completion of the test. The hot air stream is repositioned to direct the air to impinge upon the central area of the test strip 25 between the grips 12, 16 of the upper and lower chucks 14, 18, that is, the gauge length of the strip. The gauge length of the strip becomes heated to the predetermined temperature as the hot air stream impinges the strip. When the air stream impinges the strip, a separation distance between the nozzle end and the test strip (which is the same or substantially the same as a distance of the thermocouple to the nozzle) can be from about 1 to about 10 inch (2.54 to 25.4 cm). In some embodiments, the separation distance is about 1.5 to 8 inch (3.8 to 20.3 cm). In other embodiments, the separation distance is about 2 to 5 inch (5.1 to 12.7 cm). In yet other embodiments, the separation distance is about 2.5 inch (6.4 cm). The capability of the means for generating 30 hot air stream to provide the desired predetermined temperature at the strip 25 during tensile testing is determined by the separation distance in combination with the temperature and airflow settings on the air gun.

The present method includes starting the tensile testing when the hot air stream at the predetermined temperature begins heating the strip 25. The tensile test is one in which load or force is exerted on the strip 25 that is extended between the grips 12, 16 by moving at least one of the chucks 14, 18 with the grip, and continuously recording the force, and the displacement of the grips until the strip, which is elongating between the grips, breaks. The chuck (and the grip that retains the strip end) is moved from about 0.5 to about 15 inch per minute (1.3 to 38.1 cm per minute) to exert the load on the strip. In some embodiments, the chuck (and the grip retains the strip end) is moved at about 1 to 12 inch per minute (2.54 to 30.5 cm per minute). In some other embodiments, the chuck (and the grip retains the strip end) is moved at about 2 to 8 inch per minute (5.1 to 20.3 cm per minute). In yet other embodiments, the chuck (and the grip that retains the strip end) is moved at about 2 inch per minute (5.1 cm per minute) to exert the load on the strip. The tensile test starts simultaneously or substantially simultaneously as the hot air stream begins heating the strip just after the stream is repositioned to impinge the strip. There may be a short delay of 1 to 10 seconds, and in some embodiments 2 to 5 seconds, in starting the test machine on a computer-controlled test machine so that the operator can start the test via the computer but be available to position the hot air stream on the test strip. As was indicated above, the means for generating 30 the hot air stream moves such that the nozzle 33 is directing the hot air stream at or substantially at the central portion of the strip, i.e., gauge length, at the beginning and throughout the run of the tensile test, even though the length of the strip between the grips is elongating during the test. The present tensile test continues heating the strip to the predetermined temperature above ambient temperature while the strip is tensioned under load between the grips, until the strip breaks. In most embodiments, the present tensile test having air at a predetermined temperature above ambient impinging the strip occurs in a relatively short period of time. This short period of time is to simulate the experience of the material during its end use and can be in some embodiments from 0.25 to 30 seconds, in other embodiments can be from 0.25 to 20 seconds, and in yet other embodiments can be from 0.25 to 10 seconds.

An alternate embodiment of the present invention is contemplated in which the strip is heated conductively instead of heated by convection, and so the means for generating a hot air stream, such as the hot air heat gun, is replaced in the alternate embodiment with a heatable member. The heatable member is one embodiment of the alternate means for heating the strip to the predetermined temperature. The heatable member, such as a rod, can be heated by any means, though heating electrically may be most suitable. The heatable member is positioned to a first position P1 in which the heatable member does not contact the strip, and is heated to the predetermined temperature above ambient temperature. The heatable member that is heated at the predetermined temperature is repositioned to a second position P2 in which the member contacts the strip. The area of contact by the heated member to the strip forms the gauge length of the strip during the tensile test. The present method for the alternate embodiment of conduction heating of the strip would be the same or substantially the same as is described herein for the embodiment of convective heating of the strip. For instance, the heatable member can be mounted onto a platform or frame of the tensile testing machine so that heated member moves with the strip as the strip elongates during testing; and, can be mounted so that the heatable member can be moved from position P1 to position P2. The method for the alternate embodiment includes mounting the strip between upper and lower chucks of a test machine per ASTM D5035 tensile test standard; positioning the heatable member adjacent the strip so that the member does not contact the strip; heating the member to a predetermined temperature above ambient temperature; repositioning the member heated at the predetermined temperature so that the member contacts the strip; and starting the tensile testing of the strip when the member heated at the predetermined temperature begins heating the strip.

In some first embodiments of the present invention the tensile test method is conducted according to ASTM D5035 standard using 1C-E system identifiers with a tensilometer using a Instron tensile “C” load cell of 50 lb, and grips having elastomeric covering on the contact surface. The means for generating a hot air stream is a Scorpion Air Heat Gun, Model F075615 hot gun (made by Sylvania, located in Danvers, Mass., USA). The nozzle opening of the gun is at a distance of about 2.5 inch (6.4 cm) from the strip, and the air gun is set to have the air temperature as it exits the nozzle at 232° C. and airflow of 27.5 scfm (779 liters per minute), to provide a predetermined temperature of 170° C. at the surface of the strip. The material is cut into strip 1 inch (2.54 cm) wide by 14 inch (35.6 cm) long, and the strip mounted vertically so that about 6 inch (15.2 cm) is between the grips, The gauge length of the strip is about 2 inch (5.1 cm). The air gun is manually pivoted or rotated to direct the nozzle from the first position P1 adjacent the strip to the second position P2 in which the air stream impinges the strip. The tensile testing on the strip being heated begins within about 10 seconds with one of the chucks moving away from the opposite chuck at about 2 inch per minute (5.1 cm per minute), and maintaining position of the hot air stream on the gauge length of the strip. Maximum force or load at which the strip breaks is recorded.

In other embodiments of the present invention, the testing is conducted at the same conditions as the first embodiment, except that the hot air gun has been modified to include a collar at the nozzle opening. The end of the collar opposite the end attached to the nozzle is rectangular shaped to correspond to the shape of the gauge length of the strip. In yet other embodiments of the present invention, the tensile test method is conducted as described above for the first embodiments, except that the temperature and air flow of the air gun is set to provide a different predetermined temperature, for example 165° C., at the surface of the strip.

The maximum force or load that the strip exhibits under the test method is recorded, and is considered the yield point or peak strength of the material. In some embodiments only one strip is tested according to the present method, and the resulting yield point or peak strength is considered representative of the tensile strength of the material. In most other embodiments, multiple strips of the material are independently tested according to the present method, and the resulting yield point or peak strength of the all the strips tested is averaged to represent the tensile strength of the material.

The modulus of elasticity is a ratio of an increment of stress to an increment of strain. The modulus of elasticity is the Young's modulus where at low strains the relationship between stress and strain is linear, such that a material can recover from stress and strain. The modulus of elasticity may also be referred to as coefficient of elasticity, elasticity modulus, or elastic modulus. The yield point is the stress point where the relationship between applied stress and strain deviates from the linear relationship associated with Young's modulus. At the yield point, material no longer recovers from induced stress and strain, and exhibits permanent plastic deformation. The yield point may also be referred to as yield strength. Typically for the materials used in the present invention the break point is beyond the yield point. The modulus of elasticity and the yield point are mechanical properties well known to those of ordinary skill. A description of these and other mechanical properties of materials, and analysis thereof, can be found in Marks' Standard Handbook for Mechanical Engineers, eds. Avalone, E. and Baumeister III, T., 9^{th} edition, Chapter 5, McGraw Hill, 1987.

The method for testing the tensile strength of the material is representative of its use in-service during thermal development, so as to determine the potential suitability of the material to perform as desired. In particular, it is desirable for the method to measure the tensile strength of a material for use as a development medium that experiences relatively high tension at an elevated temperature for a relatively short period of time. In some embodiments, the development medium can be a web or sheet of an absorbent material. In most embodiments, the absorbent material is a nonwoven material. In other embodiments the development medium can be a web or a sheet of an absorbent material and a sheet or web of support that may be absorbent, partially absorbent, or not absorbent. The absorbent material and the support can be pre-joined or joined at the time of thermal development. As such tensile testing of the development medium that is a composite of an absorbent material and a support can be done individually with a strip of each material, or can be done with a strip of the composite material forming the development medium. Due to the number of manufacturers of polymeric film materials, and the variety of methods and process by which the polymeric films are made, it is difficult to define an absolute range of tensile strength of the material that is tested according to the present method. Even for materials, such as nonwovens, used as development medium in a thermal development process for preparing relief printing forms, an absolute range of the tensile strength of the material can be difficult unless the manufacturer and the particular type of nonwoven made by the manufacturer are taken into account. However, comparison testing of the tensile strength of nonwoven materials according to the present method can demonstrate that there is a difference in the tensile strength between acceptable material having low failure rate during thermal development and unacceptable material having high failure rates during thermal development when tested according to the present method. The difference in tensile strength can help to identify the potential for nonwoven materials that will not perform well (that is, have an increased potential to break, wrap, stretch, distort, delaminate, or lint) during a process of preparing a printing form from a precursor by thermal development from nonwoven materials that may perform well during thermal development (that is, materials that do not or only minimally break, wrap, stretch, distort, delaminate, or lint). In some embodiments, the difference in tensile strength (as determined by the present method) between non-acceptable nonwoven and acceptable nonwoven, which are made by the same manufacturer, can be from 5 to 35% lower tensile strength for non-acceptable nonwovens compared to the tensile strength of acceptable nonwovens. In other embodiments, the difference in tensile strength (as determined by the present method) between non-acceptable and acceptable nonwoven materials, which are made by the same manufacturer, can be from 10 to 30% lower tensile strength for non-acceptable nonwovens compared to the tensile strength of acceptable nonwovens.

### Thermal Development Process

Following an overall exposure to UV radiation through a mask, a photopolymerizable element is treated to remove unpolymerized areas in the photopolymerizable layer and thereby form a relief image. The treating step removes at least the photopolymerizable layer in the areas which were not exposed to actinic radiation, i.e., the unexposed areas or uncured areas, of the photopolymerizable layer. Except for the elastomeric capping layer, typically the additional layers that may be present on the photopolymerizable layer are removed or substantially removed from the polymerized areas of the photopolymerizable layer. The thermal treating step also removes the in-situ mask image (which had been exposed to actinic radiation) and the underlying unexposed areas of the photopolymerizable layer.

Thermal development heats the photosensitive element, sometimes referred to as a precursor, to a development temperature that causes unexposed portions, i.e., unpolymerized or uncured portions, of the composition layer to liquefy, i.e., melt or soften or flow, and be removed or carried away by contact with the absorbent material or the development medium. Dry development may also be called thermal development, or thermal treating. Cured portions of the photosensitive layer have a higher melting or softening or liquefying temperature than the uncured portions and therefore do not melt, soften, or flow at the thermal development temperatures. Thermal development of photosensitive elements to form flexographic printing plates is described in U.S. Pat. No. 5,015,556; U.S. Pat. No. 5,175,072; U.S. Pat. No. 5,215,859; U.S. Pat. No. 5,279,697; and U.S. Pat. No. 6,797,454. A preferred method for removing the uncured portions is by contacting an outermost surface of the photopolymerizable element to an absorbent surface, such as a development medium, to absorb or wick away or blot the liquefied portions. The photosensitive element includes a substrate and at least a composition layer mounted on the substrate. The composition layer is capable of being partially liquefied. If the photopolymerizable element includes one or more additional layers on the photopolymerizable layer, it is preferred that the one or more additional layers are also removable in the range of acceptable developing temperatures for the photopolymerizable layer. The development medium may also be referred to herein as development material, development web, and web. The absorbent material may also be referred to herein as absorbent medium, absorbent web, and absorbent layer.

The term “melt” is used to describe the behavior of the unirradiated portions of the composition layer subjected to an elevated temperature that softens and reduces the viscosity to permit absorption by the absorbent material. The material of the meltable portion of the composition layer is usually a viscoelastic material which does not have a sharp transition between a solid and a liquid, so the process functions to absorb the heated composition layer at any temperature above some threshold for absorption in the development medium. Thus, the unirradiated portions of the composition layer soften or liquefy when subjected to an elevated temperature. However throughout this specification the terms “melting”, “softening”, and “liquefying” may be used to describe the behavior of the heated unirradiated portions of the composition layer, regardless of whether the composition may or may not have a sharp transition temperature between a solid and a liquid state. A wide temperature range may be utilized to “melt” the composition layer for the purposes of this invention. Absorption may be slower at lower temperatures and faster at higher temperatures during successful operation of the process.

The use of the term absorption in defining the relative physical property between the absorbent material of the development medium and the melted uncured elastomeric composition is not intended to be limited to particular absorptive phenomena. There need not be penetration of the melted composition into the body of fibers, filaments or particles used for the absorbent material. The absorption into the bulk of the absorbent material may be only by surface wetting of the interior bulk. The driving force for the movement of the melted elastomeric composition into the absorptive areas of the development medium may be one or more of surface tension, electrical forces, polarity attraction or other physical forces known to assist in promoting philicity (that is, an affinity for), adsorption, or absorption of materials. The driving force may also include pressure driven flow into a porous media.

The thermal treating steps of heating the photopolymerizable element and contacting an outermost surface of the element with development medium can be done at the same time, or in sequence provided that the uncured portions of the photopolymerizable layer are still soft or in a melt state when contacted with the development medium. The at least one photopolymerizable layer (and the additional layer/s) are heated by conduction, convection, radiation, or other heating methods to a temperature sufficient to effect melting of the uncured portions but not so high as to effect distortion of the cured portions of the layer. The one or more additional layers disposed above the photopolymerizable layer may soften or melt or flow and be absorbed as well by the development medium. The photosensitive element is heated to a surface temperature above about 40° C., preferably from about 40° C. to about 230° C. (104-446° F.) in order to effect melting or flowing of the uncured portions of the photopolymerizable layer. By maintaining more or less intimate contact of the development medium with the photopolymerizable layer that is molten in the uncured regions, a transfer of the uncured photosensitive material from the photopolymerizable layer to the development medium takes place. While still in the heated condition, the development medium is separated from the cured photopolymerizable layer in contact with the support layer to reveal the relief structure. A cycle of the steps of heating the photopolymerizable layer and contacting the molten (portions) layer with the development medium can be repeated as many times as necessary to adequately remove the uncured material and create sufficient relief depth. However, it is desirable to minimize the number of cycles for suitable system performance, and typically the photopolymerizable element is thermally treated for 5 to 15 cycles. Intimate contact of the development medium to the photopolymerizable layer (while in the uncured portions are melt) may be maintained by the pressing the layer and the development medium together.

Apparatuses suitable for thermally developing the photopolymerizable element are disclosed by Peterson et al. in U.S. Pat. No. 5,279,697, and also by Johnson et al. in U.S. Pat. No. 6,797,454. The photopolymerizable element in all embodiments is in the form of a plate. However, it should be understood that one of ordinary skill in the art could modify each of the disclosed apparatuses to accommodate the mounting of the photopolymerizable element in the form of a cylinder or a sleeve.

The development medium can include materials that absorb, blot, wick, or collect molten polymer composition from the photosensitive element or precursor, and may be referred to as an absorbent material or web. The absorbent material is selected to have a melt temperature exceeding the melt or softening or liquefying temperature of the unirradiated or uncured portions of the radiation curable composition and having good tear resistance at the same operating temperatures. Preferably, the absorbent material withstands temperatures required to process the photosensitive element during heating. The absorbent material is selected from non-woven materials, paper stocks, fibrous woven materials, open-celled foams, porous materials that contain a fraction or a substantial fraction of their included volume as void volume. The absorbent material is typically a continuous web, but can be in sheet form. The absorbent material should also possess a high absorbency for the molten elastomeric composition as measured by the grams of elastomer that can be absorbed per square millimeter of the absorbent medium. It is also desirable that fibers are bonded in absorbent medium so that the fibers are not deposited into the printing form during development. In most embodiments the absorbent material is selected from non-woven webs of nylon or polyester. The absorbent material has a thickness between 2 to 25 mils (0.005 to 0.064 cm). In some embodiments the thickness of the absorbent material is 2 to 20 mils (0.005 to 0.051 cm), and in other embodiments is 4 to 15 mils (0.010 to 0.038 cm).

Optionally, the development medium can include more than one material. The development medium can include a support adjacent to the absorbent material and opposite the exterior surface of the photosensitive element. The support is selected to be tear resistant and heat resistant, that is, having a melt temperature exceeding the melt or softening or liquefying temperature of the unirradiated or uncured portions of the radiation curable composition. The support can be selected to provide improved mechanical properties when combined with the absorbent material. In some embodiments, the support is non-porous or at least non-absorbing so as to prevent migration of the molten polymer from the absorbent material through to underlying structures, i.e., contact member, in the apparatus. A support that is only slightly or completely porous or absorbing of the polymeric melt may also be suitable to stabilize the absorbent material from stretching and/or distorting. A slightly or completely porous or absorbing support may still provide some barrier functionality to the development medium, depending upon characteristics of the support material such as, for example, density of fibers, fiber diameter, pore size, support thickness, and heat resistant coating/s. The support is not limited and can be selected from polymeric films, paper, metals, fabrics, nonwovens, and combinations thereof. Examples of suitable combinations include metalized polymeric films, and fabrics with nonwovens. The support can be almost any polymeric material that forms films that are non-reactive and remain stable throughout the processing conditions. Examples of suitable film supports include cellulosic films and thermoplastic materials such as polyolefins, polycarbonates, and polyester. Preferred are films of polyethylene terephthalate and polyethylene naphthalate. Examples of metals suitable as the support include aluminum, nickel, and steel. There can be some overlap of materials suitable as the absorbent material and as the support, such as papers, fabrics, and nonwovens, due to the plethora of materials available that may have the characteristics suitable to function as the absorbent material and as the support. For instance, a variety of paper stocks are available with different strengths and porosities, such that some have suitable porosity to function as the absorbent material and others have suitable mechanical strength to function as the support.

The support can be in sheet form or a continuous web, but is preferably in the same form as the absorbent material. The thickness of the support is not particularly limited, provided that the support has sufficient strength to minimize or reduce stretch and/or distortion of the absorbent material and does not unduly influence heat transfer from the contact member, e.g., hot roll, through the development medium. In one embodiment, the thickness of the support is between about 0.01 mm and about 0.38 mm (0.4-15 mils). In another embodiment, the thickness of the support is between about 2.540 micron to about 0.01 mm (0.1-0.4 mils).

After the treatment step, the photopolymerizable element is essentially a printing form having relief surface of raised elements and recessed areas.

### EXAMPLES

### Example 1

The following Example demonstrates the difference in maximum breaking load exhibited by testing materials that experience different conditioning prior to tensile testing, and in particular materials that experience different conditioning by the application and location of heat prior to and during tensile testing .

### Test Method 1

Test Method 1 is an embodiment of the present invention in which tensile testing of a material that is suitable as a development medium for thermal development was conducted at the following conditions. A tensilometer, Instron Model No. 1125, with MTS Renew software package (from Eden Prairie, Minn., USA) set up according to ASTM D5035-11 having a Instron tensile “C” load cell of 50 lb, and pneumatically-controlled grips having 1 mm thick soft elastomeric covering on the opposite contact surfaces of the jaw of the grip. The means for generating a hot air stream was a Scorpion Air Heat Gun, Model F075615 hot gun (made by Sylvania, located in Danvers, Mass., USA). The nozzle opening of the gun was at a distance of about 2.5 inch (6.4 cm) from the strip, and the air gun was set to have the air temperature as it exits the nozzle at 232° C. and airflow of 27.5 scfm, to provide a predetermined temperature of 170° C. at the surface of the strip. The nozzle end of the hot air gun included a collar that at its open end (that was adjacent the strip) a rectangular shape of about 1 in by 3 in (2.5 cm by 7.6 cm) which directed the air stream to impinge about a 3 in (7.6cm) gauge length of the strip. The material was cut into strip 1 inch (2.54 cm) wide by 14 inch (35.6 cm) long, and the strip mounted vertically so that about 6 inch (15.2 cm) was between the grips, The gauge length of the strip was about 2 inch (5.1 cm). The air gun was mounted on a platform and manually pivoted to direct the nozzle from the first position P1 adjacent the strip to the second position P2 in which the air stream impinges the strip. The tensile testing on the strip being heated began within 10 seconds with one of the chucks moving away from the opposite chuck at about 2 inch per minute (5.1 cm per minute), and maintaining position of the hot air stream on the gauge length of the strip. Maximum force or load at which the strip breaks was recorded.

### Test Method 2

Test Method 2 for tensile testing of the material as conducted as described for Test Method 1 except that the strip was conditioned to the predetermined temperature in an oven that surrounded the upper and lower chucks of the tensilometer. The tensilometer was the same as described for Test Method 1. The oven was a United, Model UEC 3.5-1000 (made by United Calibration Corp., located in Huntington Beach, Calif., USA). The oven was heated to the desired predetermined temperature, the door opened, the strip clamped in the grips, and then the door was closed. The oven recovered temperature in less than 3 minutes and the strip was allowed to heat for a total of 5 minutes before tensile testing was started. The temperature in the oven was the predetermined temperature of 170° C. Similar to Test Method 1, the material was cut into strips 1 inch (2.54 cm) wide by 14 inch (35.6 cm) long, and the strip mounted vertically so that about 6 inch (15.2 cm) was between the grips, The gauge length of the strip was about 2 inch (5.1 cm). The tensile testing on the strip that was heated began with one of the chucks moving away from the opposite chuck at about 2 inch per minute (5.1 cm per minute), and maintaining the temperature in the oven at the predetermined temperature. Maximum force or load at which the strip broke was recorded.

### Test Method 3

As a control, tensile testing of the material was conducted as described for Test Method 1 except that the strip was not heated during tensile testing, and instead was conditioned and tested at room temperature.

A nonwoven material from each of three different manufacturers, identified as Nonwoven A, Nonwoven B, and Nonwoven C, was tested. Multiple strips of the nonwoven material were cut, and single strips were independently tested according to Test Method 1, Test Method 2, and Test Method 3, and the maximum breaking load reported as an average.

| | Nonwoven A | Nonwoven B | Nonwoven C |
|---|---|---|---|
| | Max. load | Max. load | Max. load |
| Test | in gram | in gram | in gram |
| Method | (ave. of 5 strips) | (ave. of 10 strips) | (ave. of 10 strips) |
| Test | 2828.4 | 12222.6 | 11893.4 |
| Method 1 | | | |
| Test | 2443.4 | 9881.3 | 8018.6 |
| Method 2 | | | |
| Test | 4109.6 | 13867.9 | 13511.0 |
| Method 3 | | | |

The results demonstrated that tensile testing of a strip of material is influenced not only by the temperature of the strip material at the test, but also by the heat experience of the strip material at tensile testing. The maximum load at break for nonwoven materials that are heated was lower than for nonwoven materials that were tested at room temperature. More interesting was finding that the maximum load at break for nonwoven materials that are heated by localizing at the gauge length and instantaneously or just prior to the start of tensile testing (i.e., less than about 10 seconds) was statistically significantly different from nonwoven materials that are overall heated and conditioned to the predetermined temperature for an extended time,

The above test methods were repeated except that a 4 mil (*cm) thick polyethylene terephthalate (PET) film was tested instead of the nonwoven materials. In some thermal development processes a composite of the PET film with a nonwoven is used as a development medium.

| | PET |
|---|---|
| | Max. load |
| | in gram |
| | (ave. of 10 strips) |
| Test | 32305.3 |
| Method 1 | |
| Test | 15707.9 |
| Method 2 | |
| Test | 35439.2 |
| Method 3 | |

In the case of PET film, the maximum breaking load that is heated by localizing at the gauge length and instantaneously or just prior to the start of tensile testing (i.e., less than about 10 seconds) was statistically significantly different from the PET that is overall heated and conditioned to the predetermined temperature for an extended time,

### Example 2

The following Example demonstrates that the present method for tensile testing is a good indicator of the performance that could be expected of materials used as a development medium in end-use during thermal development.

Two lots of the same type of nonwoven material from the same manufacturer were prepared into rolls for use as a development medium in the preparation of flexographic relief printing plates from printing form precursors by thermal development in thermal development processors, such as CYREL® FAST TD1000 and CYREL® FAST4260, sold by DuPont (Wilmington, Del., USA). The two lots of nonwoven materials were tested to be equivalent based on standard quality control tests that included basis weight, thickness, and ASTM D5035 tensile test that was conducted at room temperature. A roll of nonwoven material was mounted into the processor and used by flexographic printing plate customers, i.e., trade shops and converters, as a development medium for thermal treatment to remove by absorbing, blotting, wicking, or collecting, uncured photopolymerizable composition from the precursor and form a relief surface suitable for printing on the printing plate. The use of the two lots of nonwoven in thermal development for the preparation of relief printing forms from photopolymerizable precursors was not particularly controlled or limited. Customers prepared by thermal development relief printing plates from various types of printing precursors, which had different polymerizable compositions, different thicknesses of the photopolymerizable layer, and may (or may not) have had a laser ablatable layer adjacent the photopolymerizable layer.

Performance of a nonwoven as the development medium was generally determined after the fact by customers reporting of one or more modes of failure of the development medium during thermal development, which includes wrapping, stretching, distorting, tearing, breaking, delaminating, linting, or sticking. Customers frequently reported back one or more problems with thermal development attributed to the development medium, which was traced to one of the lots of the nonwoven material from the manufacturer. The lot of nonwoven material that had a high or frequent report back of failure was identified as having unacceptable performance for thermal development. The other lot of nonwoven material from the manufacturer had acceptable performance as the development medium since there were no report backs by customers of failures by the development medium during thermal treatment. .

The same two lots of the nonwoven material were subsequently tested according to the test methods as described above, Test Method 1, Test Method 2, and Test Method 3. Multiple strips were cut from each batch, and single strips were independently tested for maximum breaking load. The results were averaged and reported in the table below. A two sample t-test was conducted on the average maximum breaking load, based on a 95% confidence interval to understand if the results of tensile testing by a particular Test Method would provide a statistically significant difference between Acceptable Material and Unacceptable Material.

| | Acceptable | Unacceptable | |
|---|---|---|---|
| | Material | Material | |
| | Average Maximum | Average Maximum | |
| | Breaking Load | Breaking Load | 2 Sample t-test |
| | (gram) | (gram) | (95% confidence) |
| Test | 3114.7 | 2630.8 | p = 0.024; |
| Method 1 | | | statistically |
| | | | different |
| Test | 2512.4 | 2166.5 | p = 0.071; |
| Method 2 | | | statistically |
| | | | indistinguishable |
| Test | 5144.7 | 5268.7 | p = 0.804; |
| Method 3 | | | statistically |
| | | | indistinguishable |

The difference of the average maximum breaking load for acceptable material versus unacceptable material is statistically significant when the p value in the 2 sample t-test is less than 0.05. Hence, the difference in average maximum breaking load between acceptable material and unacceptable material is only statistically significant for Test Method 1 which is an embodiment of the present invention. The difference in average maximum breaking load between acceptable material and unacceptable material is statistically indistinguishable for Test Method 2 (oven testing) and Test Method 3 (room temperature testing).

The results show that the average maximum breaking load by tensile testing the two lots of nonwoven material at room temperature provided an overlap of the confidence intervals that this test could not be used to distinguish performance of the material at a thermal development temperature above ambient. The results also show that the average maximum breaking load by tensile testing the two lots of nonwoven material that are preconditioned to a predetermined temperature in an oven was statistically indistinguishable. That is, Test Method 2 did not produce results with a statistically significant difference that would have predicted the difference in performance in the end-use application for thermal development of photopolymerizable printing forms. The average maximum breaking load by tensile testing the two lots of nonwoven material that are heated at a predetermined temperature as tensile testing begins was statistically distinguishable, that is the present test method is a very good predictor of performance of the material in end use in which the material is quickly brought to a temperature above ambient temperature while under tension. The results indicate that the present method for tensile testing an electrically non-conductive material can be used a quality control test to identify if materials for use as a development medium in a thermal treatment process for preparing plates will suitably perform without or with only minimal failures.

1. A method for testing tensile strength of an electrically nonconductive strip at an above-ambient temperature comprising:
mounting the strip between upper and lower chucks of a tensile test machine per ASTM-D5035 tensile testing standard;
positioning a means for generating a hot air stream adjacent the strip so that the stream does not contact the strip;
heating the hot air stream to a predetermined temperature above ambient temperature;
repositioning the hot air stream so that the stream impinges the strip; and
starting the tensile testing of the strip when the hot air stream at the predetermined temperature begins heating the strip.

2. The method of claim 1 wherein the electrically nonconductive strip comprises a nonwoven material and wherein the predetermined temperature is 170° C.
The methhod of claim 1 wherein the predetermined temperature is a temperature from 90 to 230° C.

3. The method of claim 1 wherein the generating means comprises a hot air heat gun.

4. The method of claim 4 further comprising mounting the hot air heat gun to pivot to direct the hot air stream adjacent the strip and to direct the hot air stream to impinge on the strip.

5. The method of claim 4 further comprising mounting the hot air heat gun onto a rotatable coupling to direct the hot air stream adjacent the strip and to direct the hot air stream to impinge on the strip

6. The method of claim 4 wherein the hot air heat gun produces a constant airflow of 20 to 50 standard cubic feet per minute (SCFM) and has a variable heat adjustment that allows the predetermined temperature to be set prior to testing.

7. The method of claim 4 wherein the hot air heat gun is mounted to the tensile test machine so that the hot air heat gun moves with the strip as the strip elongates during testing.

8. The method of claim 1 wherein the upper and lower chucks are positioned at a first distance for mounting the strip, and the starting of tensile strength testing comprises separating the upper and lower chucks causing the strip to elongate, and measuring force applied to the strip and distance between the upper and lower chucks.

9. The method of claim 8 wherein the upper and lower chucks continues to separate until the strip breaks, and the force exerted on the strip at break is the tensile strength of the strip.

10. The method of claim 1 wherein the electrically nonconductive strip is a material selected from a polymeric film and a polymeric nonwoven and wherein the predetermined temperature is a temperature between the glass transition temperature of the material and the melt point or degradation temperature of the material.

11. An apparatus for testing tensile strength of an electrically nonconductive strip at an above-ambient temperature comprising:
upper and lower chucks of a tensile test machine adapted to mount the strip per ASTM-D5035 tensile testing standard;
means for generating a hot air stream at a predetermined temperature above ambient temperature; and
means for positioning the generating means so that the hot air stream moves from a position that does not impinge the strip to a position that impinges the strip.

12. e apparatus of claim 12 wherein the generating means comprises a hot air heat gun.

13. The apparatus of claim 13 wherein the hot air heat gun is adapted to produce a constant airflow of 20 to 50 standard cubic feet per minute (SCFM) with a variable heat adjustment that allows the predetermined temperature to be set prior to testing.

14. The apparatus of claim 12 wherein the means for generating comprises a hot air heat gun having a nozzle opening; and, a collar mounted at the nozzle opening that emits the hot air stream.

15. The apparatus of claim 15 wherein the collar has an end that is opposite the nozzle opening, the collar end having a cross-sectional shape to match a gauge length of the strip where the hot hair stream impinges.

16. The apparatus of claim 12 wherein the positioning means comprises a pivotable support on which a hot air heat gun is mounted that pivots the heat gun to direct the hot air stream away from the strip and to direct the hot air stream to impinge on the strip.

17. The apparatus of claim 17 wherein the pivotable support is attached to the tensile test machine that also supports the upper chuck so that the hot air heat gun moves with the electrically nonconductive strip as the strip elongates during testing.

18. The apparatus of claim 12 wherein the positioning means comprises a ratable coupling on which a hot air heat gun is mounted that move the heat gun to direct the hot air stream away from the strip and to direct the hot air stream to impinge on the strip.

19. A method for preparing relief pattern from a photosensitive element having an exterior surface and containing a composition layer capable of being partially liquefied, comprising:
heating the exterior surface to a temperature sufficient to cause a portion of the layer to liquefy; and
contacting a development medium to the exterior surface;
wherein the development medium is a electrically non-conductive material having the tensile strength that is determined according the method of claim 1.

20. A method for testing tensile strength of an electrically nonconductive strip at an above-ambient temperature comprising:
mounting the strip between upper and lower chucks of a tensile test machine per ASTM-D5035 tensile testing standard;
positioning a heatable member adjacent the strip so that the member does not contact the strip;
heating the member to a predetermined temperature above ambient temperature;
repositioning the member heated at the predetermined temperature so that the member contacts the strip; and
starting the tensile testing of the strip when the member heated at the predetermined temperature begins heating the strip.
